(19) United States
(12) Patent Application Publication
(10) Pub. No.: US 2019/0316683 A1
(43) Pub. Date: Oct. 17, 2019

(54) DESCRIPTION HYDRAULIC PLUNGER PUMP VARIABLE CONTROL STRUCTURE AND CONTROL METHOD FOR THE SAME

(71) Applicants: JIANGSU HENGLI HYDRAULIC TECHNOLOGY CO., LTD., Jiangsu (CN); JIANGSU HENGLI HYDRAULIC CO., LTD., Jiangsu (CN)

(72) Inventors: Liping Wang, Jiangsu (CN); Yanyan Liu, Jiangsu (CN); Tong Li, Jiangsu (CN)

(21) Appl. No.: 16/340,548

(22) PCT Filed: Nov. 6, 2017
(86) PCT No.: PCT/CN2017/109546

§ 371 Date: Apr. 9, 2019

(30) Foreign Application Priority Data
Feb. 10, 2017 (CN) 2017100729180

(51) Int. Cl. F16K 1/20; F16K 27/00; F16K 17/10; F16K 31/44

(52) U.S. Cl. CPC F16K 1/2007; F16K 31/445; F16K 17/10; F16K 27/003

(57) ABSTRACT

A hydraulic plunger pump variable control structure (100) and a control method for the same are provided. The hydraulic plunger pump variable control structure (100) includes a valve body (1), a main valve core (2) and a main valve sleeve (3). The main valve core (2) has a first end provided with a spring loaded assembly (4), and a second end provided with a pilot valve core (6), the spring loaded assembly being configured to provide a reverse preloading force. The main valve sleeve (3) is connected with a feedback rod (5) that is connected with a variable piston pump. A valve sleeve (7) is disposed outside the main valve core (2). The pilot valve core (6) is pushed by hydraulic oil to overcome the preloading force of the spring loaded assembly (4), thereby driving the main valve core (2) to move; the moved main valve core (2) produces relative displacement with respect to the valve sleeve (7), controls the hydraulic oil to flow into the variable piston pump, and during the movement of the variable piston pump, drives the main valve sleeve (3) along an opposite direction of a movement direction of the main valve core (2).

### FIELD

The present disclosure relates to a technical field of machinery manufacturing, and more particularly to a hydraulic plunger pump variable control structure and a control method for the same.

### BACKGROUND

A hydraulic plunger pump is commonly used in engineering machinery, and power control is a common control mode. Several kinds of power-control pumps currently common on the market have their own characteristics in terms of structure principle and design, but they have respective constraints presented as follows.

For a pump structure with the use of change in differential pressure to carry out the power control, there will be mutual interference between differential pressure control and power control, affecting the control accuracy and responsiveness.

For a pump structure in a power control mode by means of L-shaped lever structure feedback, the control accuracy is high, but the parts are numerous and complex, and the cost is high.

A pump structure in a control mode with the use of a lever to drive feedback of a valve sleeve (body) has relatively few parts and a simple structure, but pressure oil participating in the control not only serves as a pilot oil source to promote opening of a control valve, but also flows through a valve opening to push a variable piston, in which an instantaneous pressure drop of the pilot oil source may affect a force exerted on the valve, and ultimately affect the responsiveness and control accuracy of the pump.

A control structure for a power control device of a plunger pump in the market is that a pilot control device and a variable control device are integrated to a power valve core, and a valve sleeve and valve core having a three-position two-way valve structural function are provided. The valve core is configured to have a step structure and form an area difference; the valve sleeve is fitted with the valve core to define a throttling port. The power control device controls communication between an inlet P and an outlet Pp or an oil drainage port T through movements of the valve core and the valve sleeve. Pressure at a pump outlet is introduced into a pressure chamber P, and the valve core is pushed to move due to an area difference between the two diameters, such that the throttling port is opened and the oil fluid enters the Pp chamber from the P chamber, thereby pushing the variable piston to move. A spring loaded mechanism is provided at another end of the valve core to pre-load a force reversely; a feedback rod is fixed and hinged to a valve body for rotation, and has a first end linked with the valve sleeve and a second end provide with an opening capable of being connected with the variable piston. The function is based on a lever principle, such that the movement direction of the variable piston is opposite to the movement direction of the valve sleeve, so as to realize a process of mechanical feedback.

The above structure has few parts and a simple structure, but pressure oil participating in the control not only serves as a pilot oil source to promote opening of a control valve, but also flows through a valve opening to push the variable piston, in which an instantaneous pressure drop of the pilot oil source may affect a force exerted on the valve, and ultimately affect the pump responsiveness and control accuracy.

### SUMMARY

Embodiments of the present disclosure seek to solve at least one of the problems existing in the related art to at least some extent. For that reason, the present disclosure provides a hydraulic plunger pump variable control structure that can reduce an effect of an instantaneous pressure drop of chamber pressure on a thrust of a valve core when a valve port is opened, enhance stability of a valve, and improve accuracy.

The present disclosure further provides a control method for the above hydraulic plunger pump variable control structure.

The hydraulic plunger pump variable control structure according to embodiments of the present disclosure includes: a valve body having an oil inlet; a valve sleeve disposed in the valve body, and having a second oil chamber communicated with the oil inlet and a third oil chamber suitable to be communicated with a variable piston pump; a main valve core movably disposed in and through the valve sleeve, and having a first end provided with a spring loaded assembly, and a second end provided with a pilot valve core, the spring loaded assembly being configured to provide a reverse preloading force; a main valve sleeve movably fitted over the pilot valve core, and provided with a first oil chamber, the first oil chamber being able to make oil at the oil inlet P flow to the pilot valve core, such that the pilot valve core can move under the action of oil pressure and the preloading force of the spring loaded assembly, to drive the main valve core to move, thereby realizing communication and dis-communication between the second oil chamber and the third oil chamber by controlling relative displacement between the main valve core and the valve sleeve; a feedback rod having a first end connected with the main valve sleeve and a second end capable of connecting the variable piston pump, such that during movement of the variable piston pump, the feedback rod drives the main valve sleeve to move in an opposite direction of a movement direction of the main valve core.

According to some embodiments of the present disclosure, the valve sleeve is fitted with the main valve core to define a valve throttling port, and opening or closure of the valve throttling port is implemented by controlling relative displacement between the main valve core and the valve sleeve; when the valve throttling port is opened, the second oil chamber is in communication with the third oil chamber, and when the valve throttling port is closed, the second oil chamber is obstructed from the third oil chamber.

Further, the valve sleeve is provided with an orifice in communication with the third oil chamber, and when the valve throttling port is opened, the orifice is communicated with the second oil chamber.

Furthermore, the main valve core is provided with a protruding portion fitted with and snapped into the orifice, and when the main valve core moves, the protruding portion and the orifice produce relative displacement so as to implement the opening or closure of the valve throttling port.

Optionally, the valve body has a first oil channel and a second oil channel therein, the oil inlet being communicated with the first oil chamber through the first oil channel, and the oil inlet being communicated with the second oil chamber through the second oil channel.

In some embodiments of the present disclosure, the pilot valve core includes two tube-body structures, an area difference exists between the two tube-body structures to form a valve-core acting surface, and hydraulic oil is suitable to act on the valve-core acting surface to drive the pilot valve core to move.

Further, the valve-core acting surface extends into an annular shape along a circumferential direction of the pilot valve core, respective diameters of the two tube-body structures are d and d1, in which d1>d, such that the area difference is π*(d1\hat{ }2−d\hat{ }2)/4, and a thrust generated by the hydraulic oil acting on the valve-core acting surface is F=π*(d1\hat{ }2−d\hat{ }2)/4*Pc, in which Pc refers to oil pressure in the first oil chamber.

In some other embodiments of the present disclosure, the valve body also has an external oil receiving port, and hydraulic oil at the external oil receiving port acts on the pilot valve core to drive the pilot valve core to move.

Further, the pilot valve core includes three tube-body structures, and adjacent two tube-body structures have an area difference therebetween to form a valve-core acting surface.

Furthermore, the valve-core acting surface extends into an annular shape along a circumferential direction of the pilot valve core, and respective diameters of the three tube-body structures are d2, d and d1 sequentially, in which d1>d>d2, such that the hydraulic oil entering from the external oil receiving port is suitable to act on an end face with an area of π*d2\hat{ }2/4 of the tube-body structure with the diameter d2, or act on a valve-core acting surface with an area of π*(d\hat{ }2−d2\hat{ }2)/4 formed between the tube-body structure with the diameter d2 and the tube-body structure with the diameter d.

The control method for the hydraulic plunger pump variable control structure according to embodiments of the present disclosure includes the following steps: making hydraulic oil entering from an oil inlet enter a first oil chamber and a second oil chamber separately, in which the hydraulic oil entering the first oil chamber acts on a pilot valve core, a thrust F is produced under the action of pressure Pc, and when the thrust F is larger than a spring preloading force, the pilot valve core moves along its axial direction; driving, by the pilot valve core, the main valve core to move along its axial direction, so as to communicate the second oil chamber with an third oil chamber, such that the hydraulic oil in the second oil chamber enters the third oil chamber to control a variable piston pump to move, thereby realizing control over pump variable; during movement of the variable piston pump, driving a main valve sleeve to move along its axial direction under the drive of a feedback rod and in an opposite direction relative to the movement of the pilot valve core, so as to realize a process of mechanical feedback.

A beneficial effect of the present disclosure lies in that the hydraulic plunger pump variable control structure and the control method for the same can reduce the effect of the instantaneous pressure drop of chamber pressure on the thrust of the valve core when the valve port is opened, thereby enhancing the valve stability and improving the accuracy.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

In order to more clearly illustrate the technical solution in the embodiments of the present disclosure, the drawings to be used in the description of the embodiments will be briefly described below. Obviously, the drawings in the following description are merely exemplary embodiments of the present disclosure, and for those skilled in the art, other drawings can be obtained based on these drawings without creative efforts.

FIG. 1 is a schematic view of a preferable embodiment of a hydraulic plunger pump variable control structure according to the present disclosure;

FIG. 2 is a schematic view of another preferable embodiment of a hydraulic plunger pump variable control structure according to the present disclosure.

### REFERENCE NUMERALS

100 hydraulic plunger pump variable control structure,
1 valve body, 11 first oil channel, 12 second oil channel,
2 main valve core, 21 valve-core acting surface,
3 main valve sleeve, 4 spring loaded assembly, 5 feedback rod, 6 pilot valve core,
7 valve sleeve, 8 orifice, 9 valve throttling port, 10 protruding portion,
Pc first oil chamber, Pd second oil chamber, Pp third oil chamber,
P oil inlet, Pi external oil receiving port.

### DETAILED DESCRIPTION

The technical solution in embodiments of the present disclosure will be described clearly and completely, and it is obvious that the described embodiments are only a part of the embodiments of the present disclosure rather than all of the embodiments. Based on the embodiments of the present disclosure, those skilled in the art can obtain all other embodiments without paying creative efforts, and all the other embodiments fall into the protection scope of the present disclosure.

In the description of the present disclosure, it is to be understood that terms such as “inner”, “outer”, “axial”, “circumferential” and the like should be construed to refer to the orientation or position relationship as then described or as shown in the drawings under discussion. These relative terms are for convenience of description, but do not indicate or imply that the device or element referred to must have a particular orientation or be constructed or operated in a particular orientation. Thus, these terms are not constructed to limit the present disclosure.

A hydraulic plunger pump variable control structure 100 according to embodiments of the present disclosure will be described below with reference to drawings.

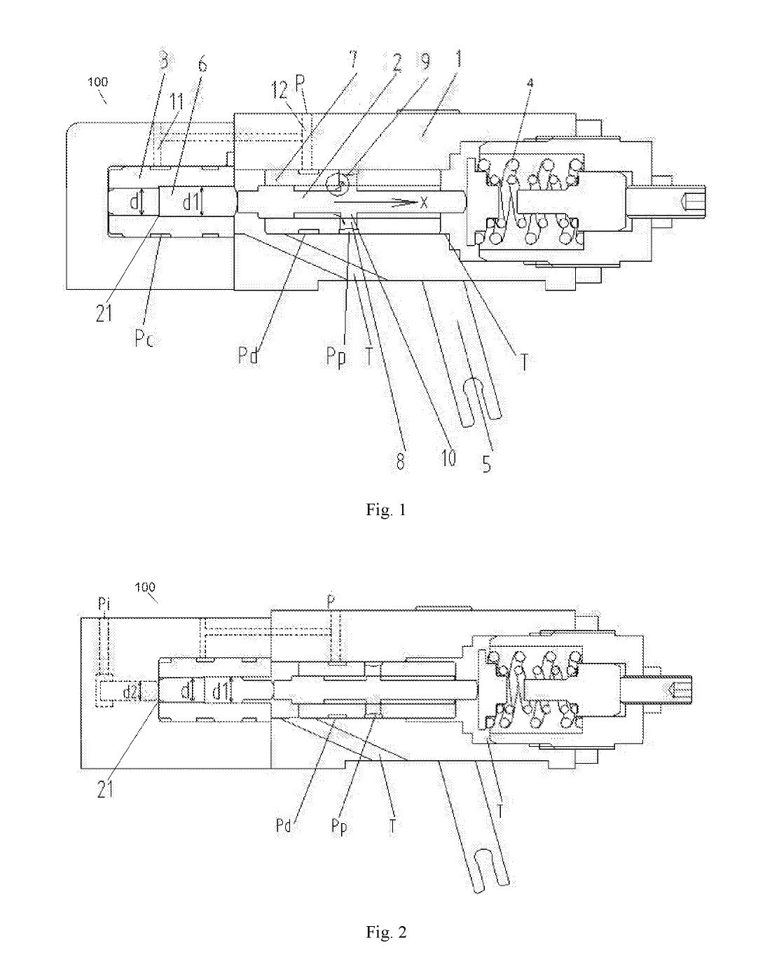

Referring to FIGS. 1 and 2, the hydraulic plunger pump variable control structure 100 according to embodiments of the present disclosure can include a valve body 1, a valve sleeve 7, a main valve core 2, a main valve sleeve 3 and a feedback rod 5.

Specifically, the valve sleeve 7 is disposed in the valve body 1, the valve body 1 has an oil inlet P, and the valve sleeve 7 has a second oil chamber Pd that is communicated with the oil inlet P and a third oil chamber Pp that can be communicated with a variable piston pump (not illustrated). The main valve core 2 is movably disposed in and through the valve sleeve 7, a first end of the main valve core 2 is provided with a spring loaded assembly 4 which supplies a reverse preloading force, and a second end of the main valve core 2 is provided with a pilot valve core 6. The main valve sleeve 3 is movably fitted over the pilot valve core 6, and provided with a first oil chamber Pc, the first oil chamber Pc being able to make oil at the oil inlet P flow to the pilot valve core 6. Thus, the pilot valve core 6 can move under the action of oil pressure and the preloading force of the spring loaded assembly 4, so as to drive the main valve core 2 to move, such that communication and dis-communication between the second oil chamber Pd and the third oil chamber Pp can be achieved by controlling relative displacement between the main valve core 2 and the valve sleeve 7. The feedback rod 5 has an end connected with the main valve sleeve 3 and the other end capable of connecting the variable piston pump. Hence, during movement of the variable piston pump, the feedback rod 5 can drive the main valve sleeve 3 to move in an opposite direction of a movement direction of the main valve core 2.

Therefore, the hydraulic plunger pump variable control structure 100 according to embodiments of the present disclosure can adopt hydraulic oil in the first oil chamber Pc to drive the pilot valve core 6 to move, thereby driving the main valve core 2 to move, and can supply oil to the variable piston pump by means of the hydraulic oil flowing from the second oil chamber Pd to the third oil chamber Pp, thereby achieving a good effect of oil supply. Compared with the prior art, the hydraulic plunger pump variable control structure 100 according to embodiments of the present disclosure can reduce an effect of an instantaneous pressure drop of chamber pressure on a thrust of a valve core when a valve port is opened, thus enhancing stability and improving accuracy of the valve.

According to some embodiments of the present disclosure, in order to improve a control effect, referring to FIGS. 1 and 2, the valve sleeve 7 can be fitted with the main valve core 2 to define a valve throttling port 9, and opening or closure of the valve throttling port 9 can be implemented by controlling the relative displacement between the main valve core 2 and the valve sleeve 7. When the valve throttling port 9 is opened, the second oil chamber Pd is in communication with the third oil chamber Pp, and the second oil chamber Pd can supply oil to the third oil chamber Pp; when the valve throttling port 9 is closed, the second oil chamber Pd is obstructed from the third oil chamber Pp.

Optionally, according to some embodiments of the present disclosure, the valve sleeve 7 can be provided with an orifice 8 in communication with the third oil chamber Pp, and as shown in FIG. 1, when the valve throttling port 9 is opened, the valve throttling port 9 can communicate the orifice 8 with the second oil chamber Pd, resulting in good communicating performance. Further, the main valve core 2 can be provided with a protruding portion 10 fitted with and snapped into the orifice 8, and when the main valve core 2 moves, the protruding portion 10 and the orifice 8 can produce relative displacement so as to implement the opening or closure of the valve throttling port 9 with higher controllability.

As shown in FIGS. 1 and 2, the valve body 1 can have a first oil channel 11 and a second oil channel 12 therein, the oil inlet P can be communicated with the first oil chamber Pc through the first oil channel 11, and the oil inlet P can be communicated with the second oil chamber Pd through the second oil channel 12, such that an effect of oil intake is good. It should be noted that one oil inlet P can be provided, or two oil inlets P can be provided, and the number of the oil inlets can be flexibly selected in the light of practical conditions.

As shown in FIG. 1, in some embodiments of the present disclosure, the pilot valve core 6 can include two tube-body structures, and an area difference exists between the two tube-body structures to form a valve-core acting surface. That is, the pilot valve core 6 includes a first tube body and a second tube body, both of which have different cross sectional areas, resulting in an area difference, and thus the valve-core acting surface can be formed at a junction of the first tube body and the second tube body. The hydraulic oil can act on the valve-core acting surface to drive the pilot valve core 6 to move, and applicability of the force is good.

Further, the valve-core acting surface can extend into an annular shape along a circumferential direction of the pilot valve core 6, and respective diameters of the two tube-body structures are denoted as d and d1, in which d1>d, as shown in FIG. 1, such that the area difference is π*(d1\hat{ }2−d\hat{ }2)/4, a thrust generated by the hydraulic oil acting on the valve-core acting surface is F=π*(d1\hat{ }2−d\hat{ }2)/4*Pc, i.e. F=π×(d1²−d²)÷4×Pc, in which Pc refers to oil pressure in the first oil chamber Pc.

As shown in FIG. 2, in some other embodiments of the present disclosure, the valve body 1 also has an external oil receiving port Pi, and hydraulic oil at the external oil receiving port Pi can act on the pilot valve core 6 to drive the pilot valve core 6 to move. In such a case, the pilot valve core 6 is subject to the oil pressure of the hydraulic oil entering from the external oil receiving port Pi and the oil pressure of the oil entering the first oil chamber Pc from the oil inlet P, and hence the pilot valve core 6 is under a sufficient and reliable driving force.

Further, referring to FIG. 2, the pilot valve core 6 can include three tube-body structures, and adjacent two tube-body structures can have an area difference therebetween to form the valve-core acting surface, such that the hydraulic oil can act on the valve-core acting surface. The valve-core acting surface can extend into an annular shape along the circumferential direction of the pilot valve core 6, and as shown in FIG. 2, respective diameters of the three tube-body structures are denoted as d2, d and d1 sequentially, in which d1>d>d2, that is, the pilot valve core 6 forms a stepped tube including three tube-body structures. The hydraulic oil entering from the external oil receiving port Pi is suitable to act on an end face with an area of π*d2\hat{ }2/4 of the tube-body structure with the diameter d2, or act on a valve-core acting surface with an area of π*(d\hat{ }2−d2\hat{ }2)/4 formed between the tube-body structure with the diameter d2 and the tube-body structure with the diameter d.

That is, the hydraulic oil entering from the external oil receiving port Pi can have two acting positions, one of which is the end face of the tube-body structure with the diameter d2, having an area of π×d2²÷4, and the other of which is the valve-core acting surface formed between the tube-body structure with the diameter d2 and the tube-body structure with the diameter d, having an area of π×(d²−d2²)÷4.

The hydraulic plunger pump variable control structure 100 according to embodiments of the present disclosure will be further described in detail with reference to a specific embodiment.

Referring to FIG. 1, a hydraulic plunger pump variable control structure 100 according to a specific embodiment of the present disclosure includes a valve body 1, a main valve core 2 and a main valve sleeve 3. A first end of the main valve core 2 is provided with a spring loaded assembly 4. The main valve sleeve 3 is connected with a feedback rod 5, and the other end of the feedback rod 5 is connected with a variable piston pump. A second end of the main valve core 2 is provided with a pilot valve core 6, a valve sleeve 7 is disposed outside the main valve core 2 and provided with an orifice 8 fitted with the main valve core 2, and the pilot valve core 6 is pushed by the hydraulic oil to overcome a preloading force of the spring loaded assembly 4, thereby moving to drive the main valve core 2 to move along a positive direction of an X axis. The moved main valve core 2 produces relative displacement with respect to the valve sleeve 7, such that a valve throttling port 9 is defined between the orifice 8 and the main valve core 2. The hydraulic oil controls the variable piston pump to move after flowing into the valve throttling port 9, and the movement of the variable piston pump drives the main valve sleeve 3 to move reversely along the movement direction of the main valve core 2, i.e. move along an opposite direction of the X axis.

The valve body 1 is provided with an oil inlet P, a first oil chamber Pc, a second oil chamber Pd and a third oil chamber Pp. The hydraulic oil entering from the oil inlet P enters the first oil chamber Pc and the second oil chamber Pd separately; the hydraulic oil in the first oil chamber Pc acts on the pilot valve core 6 to drive the pilot valve core 6 to move, such that the main valve core 2 is moved to open the valve throttling port 9; and the hydraulic oil in the second oil chamber Pd enters the third oil chamber Pp through the valve throttling port 9 to control the variable piston pump to move.

The pilot valve core 6 has two tube-body structures with different diameters, the two tube-body structures have an area difference to form a valve-core acting surface, and the hydraulic oil acts on the valve-core acting surface to drive the pilot valve core 6 to move.

In addition, the main valve core 2 is provided with a protruding portion 10, the protruding portion 10 is fitted with and snapped into the orifice 8 of the valve sleeve 7, and the main valve core 2 is moved to produce displacement between the protruding portion 10 and the orifice 8 of the valve sleeve 7, thus defining the valve throttling port 9.

Referring to FIG. 2, a hydraulic plunger pump variable control structure 100 according to a specific embodiment of the present disclosure is substantially identical to the structure shown in FIG. 1, and the main difference lies on the valve body and the pilot valve core. Specifically, in this embodiment, the valve body 1 is further provided with an external oil receiving port Pi, and the hydraulic oil at the external oil receiving port Pi can act on the pilot valve core 6 to drive the pilot valve core 6 to move.

Moreover, the pilot valve core 6 has three tube-body structures with different diameters, and adjacent two adjacent two tube-body structures can have an area difference therebetween to form the valve-core acting surface, such that the hydraulic oil can act on the valve-core acting surface to drive the pilot valve core 6 to move.

A control method for a hydraulic plunger pump variable control structure 100 according to embodiments of the present disclosure will be described in detail with reference to drawings. The control method can include the following steps:

a. The hydraulic oil entering from the oil inlet P enters the first oil chamber Pc and the second oil chamber Pd separately, in which the hydraulic oil entering the first oil chamber Pc acts on the pilot valve core, a thrust F is produced under the action of pressure Pc, and when the thrust F is larger than a spring preloading force, the pilot valve core moves along its axial direction, for example, along a positive direction of an X axis.

b. The main valve core is driven by the pilot valve core to move along its axial direction, for example, along the positive direction of the X axis shown in FIG. 1, so as to communicate the second oil chamber Pd with the third oil chamber Pp, such that the hydraulic oil in the second oil chamber Pd enters the third oil chamber Pp to control a variable piston pump to move, realizing control over pump variable. The hydraulic plunger pump variable control structure 100 according to the present disclosure has a valve throttling port, and the valve throttling port can be opened to communicate the second oil chamber Pd with the third oil chamber Pp.

c. A feedback rod is connected with the variable piston pump; when the variable piston pump moves, a main valve sleeve moves along its axial direction under the drive of the feedback rod and moves in an opposite direction relative to the movement of the pilot valve core, for example, along a reverse direction of the X axis shown in FIG. 1, so as to realize a process of mechanical feedback.

Differing from the prior art, the control method for the hydraulic plunger pump variable control structure can reduce an effect of an instantaneous pressure drop of chamber pressure on the thrust of the valve core when the valve port is opened, thus enhancing stability of the valve and improving accuracy.

Regarding the structure shown in FIG. 1, in step a, two tube-body structures of the pilot valve core 6 have different diameters d and d1, in which d1 is larger than d to form an area difference of π*(d1\hat{ }2−d\hat{ }2)/4, and the hydraulic oil acts on a valve-core acting surface 21 having this area difference to produce the thrust F=π*(d1\hat{ }2−d\hat{ }2)/4*Pc.

Regarding the structure shown in FIG. 2, in step a, three tube-body structures of the pilot valve core 6 have different diameters d, d1 and d2, the valve body has the external oil receiving port Pi, and the hydraulic oil entering from the external oil receiving port Pi is suitable to act on an end face with an area of π*d2\hat{ }2/4 of the tube-body structure with the diameter d2, or act on a valve-core acting surface with an area of π*(d\hat{ }2−d2\hat{ }2)/4 formed between the tube-body structure with the diameter d2 and the tube-body structure with the diameter d, thereby driving the pilot valve core 6 to move.

Other constructions of the hydraulic plunger pump variable control structure 100 according to embodiments of the present disclosure and other operations of the control method for the same are known to those skilled in the art, which will not be elaborated herein.

The above only involves embodiments of the present disclosure, and is not intended to limit a patent scope of the present disclosure. Any equivalent structure or equivalent process made based on the contents of the specification of the present disclosure, as well as either direct or indirect applications in other related technical fields, is likewise included in the protection scope of the present disclosure.

1. A hydraulic plunger pump variable control structure, comprising:
a valve body having an oil inlet;
a valve sleeve disposed in the valve body, and having a second oil chamber communicated with the oil inlet and a third oil chamber suitable to be communicated with a variable piston pump;
a main valve core movably disposed in and through the valve sleeve, and having a first end provided with a spring loaded assembly, and a second end provided with a pilot valve core, the spring loaded assembly being configured to provide a reverse preloading force;
a main valve sleeve movably fitted over the pilot valve core, and provided with a first oil chamber, the first oil chamber being able to make oil at the oil inlet flow to the pilot valve core, such that the pilot valve core can move under the action of oil pressure and the preloading force of the spring loaded assembly, to drive the main valve core to move, thereby realizing communication and dis-communication between the second oil chamber and the third oil chamber through controlling relative displacement between the main valve core and the valve sleeve;
a feedback rod having a first end connected with the main valve sleeve and a second end capable of connecting the variable piston pump, such that during movement of the variable piston pump, the feedback rod drives the main valve sleeve to move in an opposite direction of a movement direction of the main valve core.

2. The hydraulic plunger pump variable control structure according to claim 1, wherein the valve sleeve is fitted with the main valve core to define a valve throttling port, and opening or closure of the valve throttling port is implemented by controlling the relative displacement between the main valve core and the valve sleeve; when the valve throttling port is opened, the second oil chamber is in communication with the third oil chamber, and when the valve throttling port is closed, the second oil chamber is obstructed from the third oil chamber.

3. The hydraulic plunger pump variable control structure according to claim 2, wherein the valve sleeve is provided with an orifice in communication with the third oil chamber, and when the valve throttling port is opened, the orifice is communicated with the second oil chamber.

4. The hydraulic plunger pump variable control structure according to claim 3, wherein the main valve core is provided with a protruding portion fitted with and snapped into the orifice, and when the main valve core moves, the protruding portion and the orifice produce relative displacement so as to implement the opening or closure of the valve throttling port.

5. The hydraulic plunger pump variable control structure according to claim 1, wherein the valve body has a first oil channel and a second oil channel therein, the oil inlet being communicated with the first oil chamber through the first oil channel, and the oil inlet being communicated with the second oil chamber through the second oil channel.

6. The hydraulic plunger pump variable control structure according to claim 1, wherein the pilot valve core comprises two tube-body structures, an area difference exists between the two tube-body structures to form a valve-core acting surface, and hydraulic oil is suitable to act on the valve-core acting surface to drive the pilot valve core to move.

7. The hydraulic plunger pump variable control structure according to claim 6, wherein the valve-core acting surface extends into an annular shape along a circumferential direction of the pilot valve core, respective diameters of the two tube-body structures are d and d1, in which d1>d, such that the area difference is π*(d1\hat{ }2−d\hat{ }2)/4, and a thrust generated by the hydraulic oil acting on the valve-core acting surface is F=π*(d1\hat{ }2−d\hat{ }2)/4*Pc, in which Pc refers to oil pressure in the first oil chamber.

8. The hydraulic plunger pump variable control structure according to claim 1, wherein the valve body also has an external oil receiving port, and hydraulic oil at the external oil receiving port acts on the pilot valve core to drive the pilot valve core to move.

9. The hydraulic plunger pump variable control structure according to claim 8, wherein the pilot valve core comprises three tube-body structures, and adjacent two tube-body structures have an area difference therebetween to form a valve-core acting surface.

10. The hydraulic plunger pump variable control structure according to claim 9, wherein the valve-core acting surface extends into an annular shape along a circumferential direction of the pilot valve core, and respective diameters of the three tube-body structures are d2, d and d1 sequentially, in which d1>d>d2, such that the hydraulic oil entering from the external oil receiving port is suitable to act on an end face with an area of π*d2\hat{ }2/4 of the tube-body structure with the diameter d2, or act on a valve-core acting surface with an area of π*(d\hat{ }2−d2\hat{ }2)/4 formed between the tube-body structure with the diameter d2 and the tube-body structure with the diameter d.

11. A control method for a hydraulic plunger pump variable control structure, wherein the hydraulic plunger pump variable control structure comprises:
a valve body having an oil inlet;
a valve sleeve disposed in the valve body, and having a second oil chamber communicated with the oil inlet and a third oil chamber suitable to be communicated with a variable piston pump;
a main valve core movably disposed in and through the valve sleeve, and having a first end provided with a spring loaded assembly, and a second end provided with a pilot valve core, the spring loaded assembly being configured to provide a reverse preloading force;
a main valve sleeve movably fitted over the pilot valve core, and provided with a first oil chamber, the first oil chamber being able to make oil at the oil inlet flow to the pilot valve core, such that the pilot valve core can move under the action of oil pressure and the preloading force of the spring loaded assembly, to drive the main valve core to move, thereby realizing communication and dis-communication between the second oil chamber and the third oil chamber through controlling relative displacement between the main valve core and the valve sleeve; and
a feedback rod having a first end connected with the main valve sleeve and a second end capable of connecting the variable piston pump, such that during movement of the variable piston pump, the feedback rod drives the main valve sleeve to move in an opposite direction of a movement direction of the main valve core,
the control method comprises steps of:
making hydraulic oil entering from an oil inlet enter the first oil chamber and the second oil chamber separately, in which the hydraulic oil entering the first oil chamber acts on the pilot valve core, a thrust F is produced under the action of pressure Pc, and when the thrust F is larger than a spring preloading force, the pilot valve core moves along its axial direction;
driving, by the pilot valve core, the main valve core to move along its axial direction, so as to communicate the second oil chamber with a third oil chamber, such that the hydraulic oil in the second oil chamber enters the third oil chamber to control the variable piston pump to move, thereby realizing control over pump variable; and
during movement of the variable piston pump, driving the main valve sleeve to move along its axial direction under the drive of a feedback rod and in an opposite direction relative to the movement of the pilot valve core, so as to realize a process of mechanical feedback.

12. The hydraulic plunger pump variable control structure according to claim 2, wherein the valve body has a first oil channel and a second oil channel therein, the oil inlet being communicated with the first oil chamber through the first oil channel, and the oil inlet being communicated with the second oil chamber through the second oil channel.

13. The hydraulic plunger pump variable control structure according to claim 3, wherein the valve body has a first oil channel and a second oil channel therein, the oil inlet being communicated with the first oil chamber through the first oil channel, and the oil inlet being communicated with the second oil chamber through the second oil channel.

14. The hydraulic plunger pump variable control structure according to claim 4, wherein the valve body has a first oil channel and a second oil channel therein, the oil inlet being communicated with the first oil chamber through the first oil channel, and the oil inlet being communicated with the second oil chamber through the second oil channel.

15. The hydraulic plunger pump variable control structure according to claim 2, wherein the pilot valve core comprises two tube-body structures, an area difference exists between the two tube-body structures to form a valve-core acting surface, and hydraulic oil is suitable to act on the valve-core acting surface to drive the pilot valve core to move.

16. The hydraulic plunger pump variable control structure according to claim 3, wherein the pilot valve core comprises two tube-body structures, an area difference exists between the two tube-body structures to form a valve-core acting surface, and hydraulic oil is suitable to act on the valve-core acting surface to drive the pilot valve core to move.

17. The hydraulic plunger pump variable control structure according to claim 4, wherein the pilot valve core comprises two tube-body structures, an area difference exists between the two tube-body structures to form a valve-core acting surface, and hydraulic oil is suitable to act on the valve-core acting surface to drive the pilot valve core to move.

18. The hydraulic plunger pump variable control structure according to claim 5, wherein the pilot valve core comprises two tube-body structures, an area difference exists between the two tube-body structures to form a valve-core acting surface, and hydraulic oil is suitable to act on the valve-core acting surface to drive the pilot valve core to move.

19. The hydraulic plunger pump variable control structure according to claim 2, wherein the valve body also has an external oil receiving port, and hydraulic oil at the external oil receiving port acts on the pilot valve core to drive the pilot valve core to move.

20. The hydraulic plunger pump variable control structure according to claim 3, wherein the valve body also has an external oil receiving port, and hydraulic oil at the external oil receiving port acts on the pilot valve core to drive the pilot valve core to move.
